(19) United States
(12) Patent Application Publication
(10) Pub. No.: US 2005/0282048 A1
(43) Pub. Date: Dec. 22, 2005

(54) Fuel cell, its fuel-feeding system, fuel cartridge and electronic equipment

(76) Inventors: Tomoichi Kamo, Naka (JP); Osamu Kubota, Hitachi (JP); Kenichi Souma, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/152,368

(22) Filed: Jun. 15, 2005

(30) Foreign Application Priority Data
Jun. 15, 2004 (JP) 2004-177069

(51) Int. Cl. H01M 8/00

(52) U.S. Cl. 429/12; 429/34; 429/53

(57) ABSTRACT

An aqueous solution fuel is fed to a fuel cell by using a propellant gas composed of a pressure has or pressure-liquefied gas. The aqueous solution fuel and the propellant gas are held in an exchangeable fuel cartridge. An ejector for ejecting the aqueous solution fuel from the fuel cartridge to the fuel cell with the propellant gas is provided at the side of the fuel cartridge or at the side of the fuel cell.

### CLAIM OF PRIORITTY

The present application claims priority from Japanese application serial no. 2004-177069, filed on Jun. 15, 2004, the contents of which are hereby incorporated by references into this application.

### BACKGROUND OF THE INVENTION

The present invention relates to a fuel cell, its fuel-feeding system, fuel cartridge and electronic equipment (for example, a portable electronic equipment such as a cellular phone, personal digital assistant, notebook type personal computer, portable camera or the like) using the same.

A fuel cell is composed at least a solid or liquid electrolyte and two electrodes (anode and cathode) that induce an electrochemical reaction, and is a power generator wherein chemical energy possessed by the fuel is directly converted into electric energy with high efficiency.

Used for the fuel is hydrogen chemically converted from fossil fuels or water; methanol, alkali hydride or hydrazine that is a liquid or a solution in an ordinary environment; or dimethyl ether that is pressure-liquefied gas. Air or oxygen gas is used for oxidant gas.

A fuel is electrochemically oxidized at the anode, while oxygen is reduced at the cathode, whereby a difference in electrical potential is caused between both electrodes. When a load is applied between both electrodes as an external circuit at this time, the movement of ion is produced in the electrolyte, so that electric energy is taken out from the external load. Therefore, various types of fuel cells have been highly expected as thermal power device-replacement large-sized power generation systems, small-sized distributed cogeneration systems or engine power generator-replacement power supplies for electric vehicles, so that development for putting fuel cells into a practical use has been actively carried out.

On the other hand, a practical use of Li ion secondary battery with high energy density has been carried out in so-called new portable equipments such as a cellular phone, a notebook type personal computer, a digital camera or the like. The technology renovation and spread in this field are remarkable, and demands have been directed to portable equipments that are more compact, more light-weight, has many functions and can be easily used at any time at any place.

In recent years, the advent of New-type power supplies for portable equipments which have high energy density and substitutes for Li ion secondary battery have been expected as the demands of an increase in the energy density due to using a power supply at any time at any place, and an increase in power consumption due to many functions.

In view of such background, a direct methanol fuel cell (DMFC: Direct Methanol Fuel Cell), a metal hydride and a hydrazine fuel cell using liquid fuels have attracted attention as being effective for compact portable and/or handy power supplies, since the volumetric energy density of the fuels are high. Among these, a DMFC having methanol as a fuel can be an ideal power supply system, since it is easy to handle and expected to be produced from a biomass in the near future.

A polymer electrolyte membrane fuel cell (PEM-FC) power generation system is composed of unit cells connected together in series or in parallel (each unit cell has a porous anode and a porous cathode arranged on both surfaces of a solid polymer electrolyte membrane); a fuel tank; fuel-feeding device; and air or oxygen-feeding device.

In order to use such a fuel cell for a power supply of a portable equipment, efforts have been made for aiming to provide a cell having higher output density, i.e., for developments of a high-performance electrode catalyst, a high-performance electrode structure and a solid polymer membrane having reduced fuel crossover (permeation).

Further, an ultimate technology for downsizing a fuel pump and an air blower has been pursued, or a system not requiring an auxiliary power such as a fuel pump and an air blower has been pursued. Since the power supply system is a power generator, it suitably needs a replenishment of fuel with power consumption. In this case, it is necessary to perform a replenishment of fuel by using a fuel cartridge in order to secure general versatility of portable equipments and further enhance convenience of portable equipments. In order to secure hermeticity and safety of the fuel cartridge and enhance energy density of a power supply, it is necessary to reduce or eliminate fuel-feeding power.

A Patent Reference 1 (Japanese Patent Laid-Open No. 2003-86218) discloses, as a conventional technique of a fuel-feeding, that dimethyl ether as a fuel is filled in a spray can and the fuel is fed to the fuel cell by a spray effect, in a direct dimethyl ether fuel cell (DDMEFC) utilizing dimethyl ether that is gas under a living environment (ordinary temperature and atmospheric pressure).

The DDMEFC is a cell wherein an oxidation reaction proceeds at the anode with the ratio of dimethyl ether and water of 1:3 mol. Dimethyl ether has a property not dissolving into water and is gas under living environment. At the anode, dimethyl ether is oxidized to produce carbon dioxide with the progression of the reaction. This produced gas is required to be emitted to the outside of the cell as exhaust gas. Gaseous dimethyl ether fuel is emitted to the outside with carbon dioxide so long as carbon dioxide is separated from dimethyl ether with any method. Therefore, 100% of dimethyl ether cannot be used as a fuel.

### SUMMARY OF THE INVENTION

An object of the present invention is to enable to use a cartridge that can easily be exchanged as a fuel-feeding source for a fuel cell, and to realize a fuel cell power generation system and a fuel-feeding system that can be operated with high fuel-efficiency, while a fuel is not substantially emitted into air during the power generation operation.

Further, the present invention aims to provide a system that requires no mechanical auxiliary power such as a pump for feeding a fuel to a fuel cell.

The present invention is characterized basically by a fuel-feeding system for a fuel cell using an aqueous solution fuel, wherein the aqueous solution fuel is fed to the fuel cell by using a propellant gas composed of an electrically inactive pressure gas or pressure-liquefied gas.

A preferable embodiment of the present invention is that an aqueous solution fuel and propellant gas are held in an exchangeable fuel cartridge. Further, an ejector for ejecting the aqueous solution fuel to a fuel cell from the fuel cartridge with the propellant gas is provided at the side of the fuel cartridge or at the side of the fuel cell.

Examples of the aqueous solution fuel held in the fuel cartridge include an aqueous methanol solution. One or more propellant gases are selected from, for example, pressure gas such as carbon dioxide, nitrogen, argon, air or the like or pressure-liquefied gas such as butane or flon. The present invention having the aforesaid configuration can be used as power supply systems for portable equipments that are more compact, more light-weight, have many functions and can be easily used at any time at any place.

According to the present invention, the fuel can be fed to the fuel cell from the fuel cartridge by a spray principle (using propellant gas). Since the fuel is an aqueous solution fuel instead of a gaseous fuel, it is possible to discharge a gas produced by a power generation operation (electrochemical reaction) as performing a gas-liquid separation between the produced gas and the aqueous solution fuel. Accordingly, a fuel is not substantially discharged in air, so that a system can be operated with high fuel efficiency. The case where the fuel is an aqueous methanol solution will be explained. An aqueous methanol solution is a liquid under ordinary temperature and atmospheric pressure. Therefore, there is no chance that a fuel, which should be fed to a fuel cell, is partly discharged to the outside without being used as a fuel, like dimethyl ether that is gas under atmospheric pressure. Consequently, chemical energy possessed by a fuel is efficiently converted into electric energy.

The use of the ejection effect of the propellant gas can realize a fuel cell system not requiring a mechanical auxiliary power such as a pump for feeding a fuel. It should be noted that, depending upon a configuration of a system, a liquid-feeding pump can be used together, and such a system can be included in the spirit of the invention.

### BRIEF DESCRIPTION OF THE DRAWINGS

FIG. 1 is an exploded perspective view showing one example of a stacked fuel cell to which the present invention is to be applied;

FIG. 2 is an exploded perspective view showing one example of a panel type fuel cell to which the present invention is to be applied;

FIG. 3(a) is a schematic view showing a fuel-feeding system of a fuel cell according to a first embodiment of the invention;

FIG. 3(b) is a schematic view showing a fuel-feeding system of a fuel cell according to a second embodiment of the invention;

FIG. 4 is a longitudinal sectional view showing one example of a fuel cartridge used in each embodiment;

FIG. 5 is a longitudinal sectional view showing one example of a fuel cartridge used in each embodiment;

FIG. 6 shows an exploded perspective view and assembly view of a vent used in the embodiment (the vent enables to separate gases from a liquid and discharge only gases to the outside);

FIG. 7 shows an exploded perspective view and assembly view of a vent used in the embodiment (the vent enables to separate gases from a liquid and discharge only gases to the outside);

FIG. 8 is a schematic view showing a fuel-feeding system of a fuel cell according to a third embodiment of the invention;

FIG. 9 is a longitudinal sectional view showing one example of a fuel cartridge used in the embodiment;

FIG. 10 is a longitudinal sectional view showing one example of a fuel cartridge used in the embodiment;

FIG. 11 is a perspective view showing a state in which the fuel cartridge of one example of the invention is attached to a fuel cell;

FIG. 12 is a partial sectional view showing a coupling between a fuel cartridge of a fuel cell power generation system and a fuel tank;

FIG. 13 shows specific structures before and after an ejector 17 of a fuel cartridge and a socket 70 at the side of the fuel tank 7 are coupled;

FIG. 14 is a sectional view showing that a fuel cell is applied to an electronic device; and

FIG. 15 is a perspective view of a notebook type personal computer.

### DETAILED DESCRIPTION OF THE INVENTION

An embodiment of the present invention will be explained.

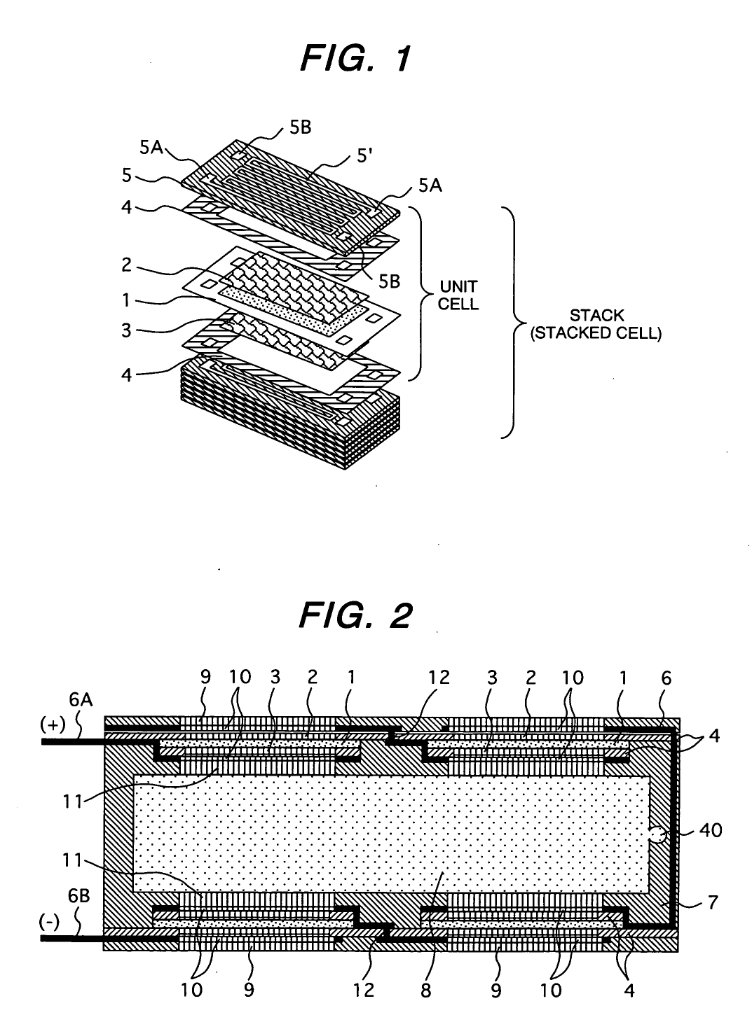

FIGS. 1 and 2 respectively show a fuel cell to which the present invention is to be applied. FIG. 1 is an exploded perspective view of a stack type fuel cell, while FIG. 2 is a partial sectional view of a panel type fuel cell.

Stack Type Fuel Cell

A fuel cell using a solid high polymer membrane is generally equipped with a plate membrane/electrode assembly (MEA: Membrane Electrode Assembly) wherein electrodes (anode and cathode) supporting a porous electrode catalyst are bonded on both surfaces of a solid electrolyte membrane; and a conductive separator. These are defined as a unit cell (single cell), whereby a plurality of unit cells are stacked to compose a fuel cell stack.

Specifically, as shown in FIG. 1, a unit cell is composed of an MEA 1 having an anode (fuel electrode) and cathode (air electrode) bonded on both surfaces of a solid high polymer electrolyte membrane, a cathode diffusion layer 2, anode diffusion layer 3, gasket 4 and separator 5. Plural single cells are stacked to compose a fuel cell, i.e., a so-called fuel cell stack.

A fuel-feeding channel 5′ is formed on one face of each separator 5, and an air-feeding channel (not shown) is formed on the other face. Further, a fuel-feeding hole 5A and an air-feeding hole 5B are bored in the MEA 1, gasket 4 and separator 5, those of which compose a laminated member. The output voltage of the stack is determined by the laminated number of the unit cell and the output current is determined by the area of the electrode forming the MEA 1.

Panel Type Fuel Cell

To eliminate an auxiliary power machine for feeding a fuel or oxidant to the fuel cell simplifies the construction of a fuel feeding system in an electric power generating device, so that it is an effective method to increase an energy density of a power supply. Therefore, some proposals have been made.

As a recent example, the following construction has been proposed in a direct methanol fuel cell (DMFC) in which methanol and water are used as a fuel (aqueous methanol solution) as disclosed in Japanese Patent Laid-Open No. 2000-268835, Japanese Patent Laid-Open No. 2000-268836, Japanese Patent Laid-Open No. 2002-343378, Japanese Patent Laid-Open No. 2003-100315, or the like.

This electric power generating system is configured to have an anode that is arranged in a manner to contact with outer wall side of a liquid fuel tank via a material for feeding a liquid fuel by capillary attraction, and further to have a solid high polymer electrolyte membrane and cathode successively bonded. Air from the outside is brought into contact with the outer surface of the cathode and oxygen in the air is diffused, thereby feeding oxygen to the side of the cathode.

This panel type power generating system does not need an auxiliary power machine for feeding a fuel and oxidant gas, thereby being capable of simplifying the configuration of the system. Further, plural cells are combined in series only by an electrical connecting, not requiring a joint member such as a separator for a unit cell used in a stack type fuel cell. Therefore, a thin panel type power supply can be formed.

FIG. 2 shows a configuration of a panel type cell used in the embodiment of the present invention.

In FIG. 2, an MEA 1, a cathode diffusion layer 2, an anode diffusion layer 3, a gasket 4, a current collecting plate 6, a fuel tank (fuel chamber) 7, an aqueous methanol solution fuel 8, a cathode slit 9, a current collector 10, an anode slit 11 and an inter-connector 12 are shown.

The structure of the MEA 1 is the same as that in FIG. 1, wherein the anode and cathode are bonded on both surfaces of the solid high polymer electrolyte membrane. Plural MEAs 1 are arranged in parallel on at least one face (both faces in this embodiment) of the fuel tank 7 holding the aqueous solution fuel 8. The anode in each MEA 1 faces the aqueous solution fuel in the fuel tank 7 via the anode diffusion layer 3,current collector 10 and anode slit 11. The current collector 10 is made of a conductive member having a hole pattern same as that of the anode slit 11.

A fuel wicking material that is porous and has a high affinity (high wettability) to an aqueous methanol solution is filled in the fuel tank 7, anode slit 11 and current collector 10. Filling the wicking material allows the fuel to be fed to the anode via the anode slit 11 and current collector 10 with a capillary attraction. Although this embodiment utilizes lo this type of wicking material (not shown), it is possible to adopt the other structure, not using the wicking material. Further, it is possible to use an absorptive material having excellent liquid-holding instead of the anode slit 11.

The cathode diffusion layer 2 is arranged on the cathode face of each MEA 1. Further, the outer surface of the cathode diffusion layer faces air through the current collector 10 and the cathode slit 9. The current collector 10 is made of a porous or slit-like conductive member as described above.

The air that is the oxidant is diffused through the cathode slit 9 and the current collector 10, and then, fed to the cathode.

FIG. 2 illustrates the one wherein two unit cells are arranged on each of two opposite faces (upper and lower faces in FIG. 2) of the fuel tank 7, i.e., a total of four unit cells are arranged. However, the invention is not limited thereto. Plural unit cells having the MEA 1 are connected in series via the current collecting plate 6, wherein they are connectable to an external device via the (−) terminal 6A and (+) terminal 6B.

The cathode diffusion layer 2 and the anode diffusion layer 3 in FIGS. 1 and 2 are respectively fitted into a window provided at the gasket 4.

A fuel passage 40 for supplying the fuel into the fuel tank 7 is formed on the side wall of the fuel tank.

The present invention aims to realize a fuel cell that does not need an auxiliary power equipment such as a fuel supply pump or air supply blower by providing a fuel-feeding system using a propellant gas as described later. This fuel-feeding system is applicable to either of the stack type cell and panel type cell.

Prior to the explanation of the fuel-feeding system, a principle of a fuel cell having an aqueous methanol solution as a fuel will be explained. The fuel cell of this type is a power generation system wherein chemical energy possessed by methanol is directly converted into electric energy by an electrochemical reaction described later.

At the side of the anode electrode, the supplied aqueous methanol solution is reacted in accordance with the formula (1) and dissociated into dioxide gas, hydrogen ion and electron.
CH₃OH+H₂O→CO₂+6H⁺+6e− (1)

The produced hydrogen ion moves from the anode to the cathode in the electrolyte membrane, and reacts on the cathode electrode with the oxygen gas diffused from the air and electron on the electrode in accordance with the formula (2), thereby producing water.
6H⁺+3/2O₂+6e−→3H₂O (2)

Therefore, the total chemical reaction causing power generation is an oxidation of methanol by oxygen to yield carbon dioxide and water as shown in the formula (3), and the chemical formula is the same as that for flame combustion of methanol.
CH₃OH+3/2O₂→CO₂+3H₂O (3)

The open-circuit voltage of the unit cell is approximately 1.2 V, and is substantially 0.85 to 1.0 V due to the influence of fuel permeating the electrolyte membrane. Although the practical voltage in load operation is not subject to any special restriction, a voltage region of about 0.3 to 0.6 V is selected in usual. Therefore, when the fuel cells are used actually as a power supply, the unit cells are used by being connected in series so that a predetermined voltage can be obtained according to the requirements of load equipments. Although the output current density of unit cell is influenced by the electrode catalyst, electrode construction, and other factors, design is made so that the power generation area of unit cell is efficaciously selected so as to obtain a predetermined current.

A material in which fine particles of platinum and ruthenium or platinum-ruthenium alloy are dispersedly supported on a carbon-based powder support is used, for example, as an anode catalyst forming the power generation section. A material in which fine particles of platinum are dispersedly supported on a carbon-based carrier is used as a cathode catalyst. These catalyst materials can be easily manufactured and used.

The amount of platinum, that is a main component of the catalyst, supported in the carbon powder is preferably not more than 50 wt %, in general. It is possible to form a high-performance electrode even by not more than 30 wt %, depending upon the improvement in the dispersion of platinum on a high-active catalyst or carbon support.

The amount of platinum in the electrode is preferably 0.5 to 5 mg/cm² in the anode and 0.1 to 2 mg/cm² in the cathode. However, the anode and cathode catalysts for the fuel cell in accordance with the present invention are not subject to any special restriction as long as they are the catalysts used for the ordinary direct methanol fuel cell. The catalyst having high performance can reduce the amount of catalyst, thus effective for reducing cost of the power source system.

Using a hydrogen ion conductive material for the electrolyte membrane can realize a stable fuel cell without being affected by carbon dioxide in air. Examples of the material include a sulfonated fluorine polymer represented by polyperfluorostyrene sulfonic acid and perfluorocarbon sulfonic acid, and a material in which a hydrocarbon polymer is sulfonated such as polystyrene sulfonic acid, sulfonated polyether sulfones, and sulfonated polyether ether ketons, or a material in which a hydrocarbon polymer is alkylsulfonated. If these materials are used as the electrolyte membrane, the fuel cell can generally be operated at a temperature of 80° C. or lower. Also, by the use of a composite electrolyte membrane in which a hydrogen ion conductive inorganic material such as tungsten oxide hydrate, zirconium oxide hydrate, and tin oxide hydrate is dispersed microscopically in a heat-resistant resin or sulfonated resin, the fuel cell can be operated in a higher temperature region. The composite electrolyte membrane using sulfonated polyether sulfones, polyether ether sulfones or hydrogen ion conductive inorganic material is particularly preferable as a membrane having low permeability of methanol that is a fuel, compared to that using polyperfluorocarbon sulfonic acids. At any rate, if an electrolyte membrane having high hydrogen ion conductivity and low methanol permeability is used, the power generation efficiency of fuel increases, so that a smaller size of generator and long-term power generation, which are the effects of the present invention, can be achieved at a higher level.

In FIG. 1, the cathode diffusion layer 2 and the anode diffusion layer 3 that are components of the stack type fuel cell have functions for supporting the MEA 1, supplying air and fuel to the electrodes corresponding to the cathode and anode, diffusing the components produced on the electrodes and reducing the contact resistance between the electrode and the separator. The cathode diffusion layer is made by the following processes. A base material of the cathode diffusion layer is a carbon fiber nonwoven fabric, a carbon fiber woven fabric or the one wherein either of these fabrics is immersed into a aqueous dispersion liquid of polytetrafluoroethylene (Teflon Dispersion D-1, manufactured by Daikin Industries, Ltd., “Teflon” is a trademark of Dupont) and then, it is dried at 80 to 120° C. and baked at 250 to 370° C. to provide a water repellency. Then, the following paste is coated on one surface of the fabric. The past is made by kneading carbon powders (e.g., carbon powders same as those used for the electrode catalyst) with an aqueous dispersion liquid of polytetrafluoroethylene in a predetermined amount. After coating the past on the fabric, the resultant one is dried at 80 to 120° C. and baked at 250 to 370° C., forming a water-repellent layer. The cathode diffusion layer is laminated such that the water-repellent layer is brought into contact with the cathode face. As for the drain of water produced with the power generation from the cathode electrode layer and the diffusion layer, a desirable condition is determined depending upon the polytetrafluoroethylene content supported on the diffusion layer, degree of dispersion or baking temperature.

The anode diffusion layer is made of a carbon fiber nonwoven fabric or woven fabric. Making the surface of the porous diffusion layer strongly hydrophilic is effective for emitting carbon dioxide produced from the aqueous solution fuel in the vicinity of the anode. Therefore, preferable diffusion layer includes the layer in which titanium oxide or hydrous titanium oxide is dispersedly supported.

In either case, the present invention is not limited to the aforesaid embodiments. For example, it is possible to use. a method wherein an electrode layer is formed beforehand on the diffusion layer and then the resultant one is bonded to the electrolyte membrane, or a method wherein the aforesaid respective diffusion layers are bonded to the MEA having the electrode layer formed beforehand on the electrolyte membrane and the resultant is integral with the gasket.

The separator 5, which is the component of the stack type fuel cell, is generally formed such that a groove through which the anode fluid (fuel) and cathode fluid (air) flow is provided on a graphitized conductive carbon plate. An internal manifold type is provided with a manifold for feeding respective fluids between the stacked cells.

The separator 5 is made of the one wherein a composite of carbon material and resin is baked and graphitized or the one wherein a mixture of graphite material and resin are molded. The separator 5, instead of the carbon material, can be made of a metal ensuring conductivity and corrosion resistance even under the power generating environment of the fuel cell, namely a metal such as stainless steel, titanium or tantalum, or a clad material wherein one of the above metals covers the other metals such as carbon steel, copper or aluminum. Specifically, a fluid flow channel is formed by stamping the metal or the clad metal, and manifolds are formed by punching the metal or the clad metal. Moreover, in a metal separator, once a corrosion-resistant noble metal has been plated on a processed surface contacting with a current-carrying part of the cell, or once a conductive carbon coating material has been applied to the surface, the contact resistance at laminated components of the cell can reduce. Thereby, it is possible to effectively increase the output density of the cell and to ensure long-term stability in performance. Further, another feature in using the metal separator is that the separator is reduced the thickness, and the cell can be downsized and reduced the weight.

A material used for the fuel tank 7 or the current collecting plate 6 shown in FIG. 2 as components of the panel type fuel cell is desirably electrically insulative basically. Examples of the material includes polyethylene, polypropylene, polyethylene telephthalate, vinyl chloride, polyacrylic resin, epoxy resin, or other engineering resins, an electrically insulative material in which these materials are reinforced by a filler etc., a carbon material excellent in corrosion resistance under the atmosphere of producing water, stainless steel, or a material wherein the surface of ordinary iron, nickel, copper, aluminum and alloy of these metals are made electrically insulative. This can be realized by providing an insulating material such as resin or rubber in order to avoid short-circuit between each unit cell.

The cathode slit 9 provided at the current collecting plate 6 and the anode slit 11 provided at the wall face of the fuel tank 7 function to feed air and fuel necessary for the power generation into the diffusion layers (air diffusion layer, fuel diffusion layer) arranged at both faces of the MEA 1. Any restriction is not imposed on its opening shape. The opening may have any optional shapes such as rectangle, circle, ellipse or the like. The open area ratio is more than 25%, preferably more than 30%. A selection is made as to the arrangement and open area ratio of a hole having a rigidity sufficient enough to compress the unit cell on which these faces are arranged.

The current collector 10 is arranged on the face of the cathode slit 9 and the anode slit 11 facing the MEA 1. It has the opening pattern same as that of the cathode slit 9 and the anode slit 11 and is made of a conductive plate having corrosion resistance. Although a material for the current collector is not particularly limited, usable materials include a carbon plate, a metal plate such as stainless steel, titanium, tantalum or the like, or a composite material such as a clad of these metal materials and other metal such as carbon steel, stainless steel, copper, nickel or the like. Further, in the metal current collector, once a corrosion-resistant noble metal has been plated on a processed surface contacting with a current-carrying part of the cell, or once a conductive carbon coating material has been applied to the surface, the contact resistance at the mounted collector can reduce. Thereby, it is possible to effectively increase the output density of the cell and to ensure long-term stability in performance.

It is effective to fill, in the fuel tank 7, the anode slit 11 and the current collector 10, a wicking material having an ability to transport a liquid by a capillary attraction for stably diffusing and feeding the liquid fuel to the anode. A material used for the wicking material may be any type so long as it has a small contact angle to the aqueous methanol solution, and is electrochemically inactive and corrosion resistant. Such material may be used in a powdery form or fibrous form. Examples of preferable materials having low filling density and a superior retention for an aqueous methanol solution include natural fibers such as glass, alumina, silica-alumina, silica, non-graphite carbon, cotton, wool, paper, silk, pulp, or the like, fibers made of polyethylene, polypropylene, polyethylene terephthalate, polyvinyl chloride, polyacryl and other engineering resins, or water absorptive polymer fibers.

Fuel-Feeding System

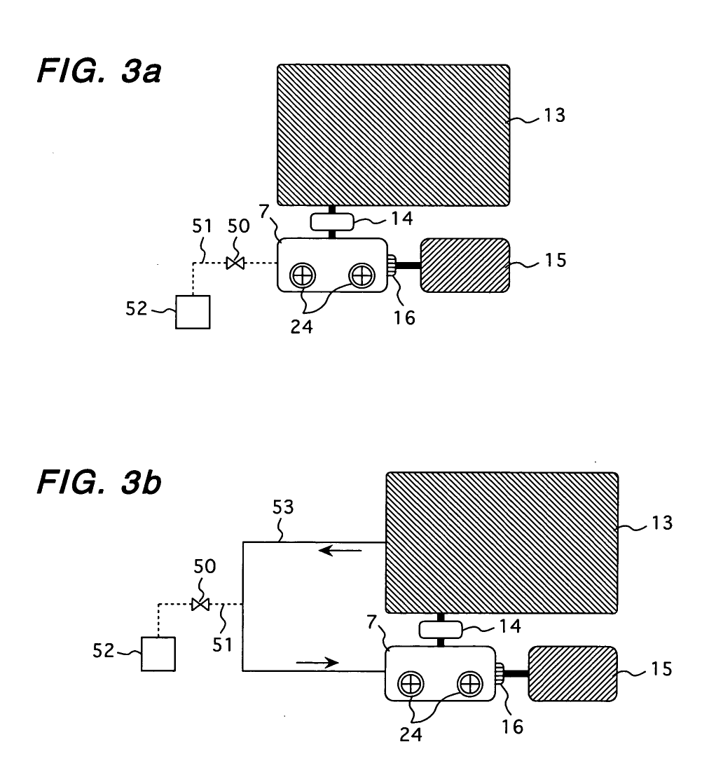

First and second embodiments of a fuel-feeding system according to the present invention are shown in FIGS. 3(a) and (b). A DMFC 13 is, for example, a fuel cell shown in FIG. 1 or FIG. 2. It is connected to the fuel tank 7 via a liquid conveying device 14. When the fuel in the fuel tank 7 is consumed, a new fuel cartridge 15 is suitably exchanged with the cartridge that has been used up, and the new cartridge 15 is attached to the fuel tank 7 via a coupling as a detachable mechanism 16, whereby a fuel can be fed at a time in the fuel tank 7.

The fuel tank 7 can be externally attached to the DMFC 13 or incorporated in the DMFC 13. The externally attached structure is suitable for a stack type fuel cell, while incorporated structure is suitable for a panel type fuel cell.

FIG. 3(a) shows an embodiment suitable for a fuel-feeding system wherein the fuel tank 7 is incorporated therein like a panel type fuel cell. In FIG. 3(a), the fuel tank 7 is shown at the outside of the fuel cell for the convenience of drawing a schematic view, but since this embodiment shows a panel type fuel cell, the fuel tank 7 is actually incorporated into the DMFC 13 as shown in FIG. 2. The liquid conveying device 14 is composed of a wicking material filled in the anode slit 11 or current collector 10. In case where the fuel concentration in the tank 7 is decreased, with the use of the aqueous solution fuel, to a degree such that a battery function cannot be provided, the aqueous solution is exchanged with a new aqueous solution. In this case, a drain tube 51 connected to a drain port of the fuel tank 7 is opened, whereby the used aqueous solution in the fuel tank 7 is collected into a collection tank 52. The used aqueous solution is collected by driving a drain pump 50 provided at the drain tube 51.

FIG. 3(b) shows an embodiment suitable for a fuel-feeding system wherein the fuel tank 7 is externally attached like a stack type fuel cell. The aqueous solution fuel fed into the fuel tank 7 circulates between the fuel tank 7 and the DMFC 13 via a circulating pipe 53. Further, the drain tube 51 connected to the circulating pipe 53 (or fuel tank 7) is opened, whereby the used aqueous solution is collected into the collection tank 52 by driving the drain pump 50.

The fuel conveying device 14 uses, for example, a wicking material having a capability of transporting a liquid by a capillary attraction. A material that transports an aqueous solution fuel by a capillary attraction may be any type so long as it is electrochemically inactive and corrosion resistant. It may be used in a powdery form or fibrous form. Examples of usable materials include natural fibers such as glass, alumina, silica-alumina, silica, non-graphite carbon, cotton, wool, paper, silk, pulp, or the like, fibers made of polyethylene, polypropylene, polyethylene terephthalate, polyvinyl chloride, polyacryl and other engineering resins, or water absorptive polymer fibers. These fibers are preferable materials having low filling density and a superior retention for an aqueous methanol solution. In order to more efficiently transport the aqueous solution fuel to the anode, an effective method is such that the diameter of a capillary tube is gradually or stepwisely decreased from the fuel tank 7 to the anode provided in the DMFC 13. Further, a method of boring a large-diameter hole in the wicking material or a method of providing a groove structure in the wicking material can rapidly discharge carbon dioxide produced in the anode through the wicking material to the outside of the system. It makes possible to stably maintain a high battery performance.

In case where the fuel tank 7 is externally attached, a method of using a diaphragm, a plunger system or a method of using other small-sized liquid conveying pump can be adopted, instead of a liquid conveying system utilizing an interfacial energy of the material (wicking material) disclosed herein.

In case where a mechanical method described above is used for conveying the fuel, it is important to select a device having more reduced power consumption in order to enhance the efficiency of a fuel cell power generation system. Additionally, it is also an effective method for reducing power for conveying a fuel that a device is intermittently driven, according to need, for the supply of the fuel.

At least one or more cap type vent 24 are provided to the fuel tank 7 for releasing only gases such as carbon dioxide produced at the anode with the power generation operation of the DMFC 13 to the outside.

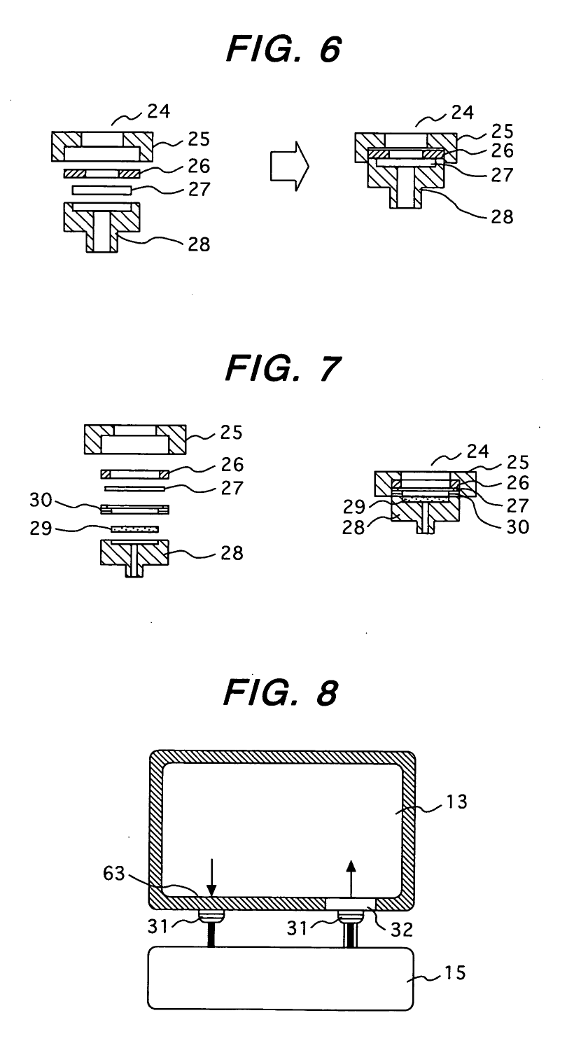

The vent cap 24 has a function that separates the aqueous solution fuel and carbon dioxide in the fuel tank 7 and release only gases to the outside of the system, thereby preventing the leakage of the aqueous solution fuel to the outside of the system. A specific shape of the vent cap 24 is shown in FIG. 6. FIG. 6 shows an exploded sectional view of the vent cap 24 according to one embodiment and its assembly view. The vent cap 24 in FIG. 6 is composed of a cap 25, gasket 26, gas-liquid separation membrane 27 and vent hole 28.

Another embodiment of the vent cap 24 is shown in FIG. 7. The components in FIG. 7 same as those in FIG. 6 are given same numerals. The different point from FIG. 6 is that a demister 29 is disposed between the gas-liquid separation membrane 27 and the vent hole 28 via a spacer 30. The demister 29 is made of, for example, a porous member wherein water repellent is made on a surface of a glass filter. A waterdrop having a large diameter is removed beforehand by the demister 29, so that the aqueous solution fuel does not come in direct contact with the gas-liquid separation membrane 27.

It is effective to use for the gas-liquid separation membrane a porous polytetrafluoroethylene membrane having strong water repellency (Gore-Tex, manufactured by W. L. Gore & Associates, Inc.) or a membrane obtained by treating a surface of a porous material with aqueous dispersion of polytetrafluoroethylene (Teflon Dispersion D-1, manufactured by Daikin Industries, Ltd.), the resultant being subject to water repellent finish. Another possible method is a mechanical structure wherein holes, among plural vent 24, that come in contact with gas are opened and the holes are closed when they come in contact with a liquid.

The detachable mechanism 16 that couples the fuel tank 7 and the fuel cartridge 15 can structurally utilize the one used for an ordinary liquid replenishment or a connector of a cartridge type replenishment device of high-pressure liquefied gas. Since the fuel-feeding system according to the present invention is used in an optional posture in a fuel cell power source system such as a portable device, it is important to select a structure wherein liquid spill does not occur even at the time of attachment or detachment from the viewpoint of user's safety or protection of an electronic component.

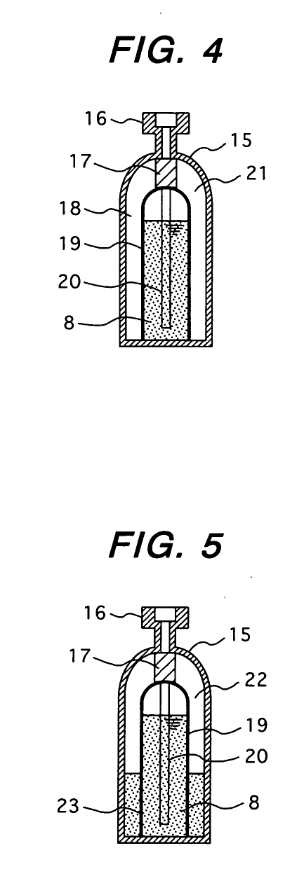

A specific embodiment of the fuel cartridge 15 used in the fuel-feeding system shown in FIG. 3 is shown in FIGS. 4 and 5. In FIG. 4, the fuel cartridge 15 is composed of a detachable mechanism (detachable device) 16 to the fuel tank 7, an ejector 17, a propellant gas chamber 18, a fuel chamber 19 and a liquid tube 20 connected to the ejector 17 arranged in the fuel chamber 19. An aqueous methanol solution 8 is held in the fuel chamber 19. Further, sealed in the propellant gas chamber 18 is pressure gas 21 such as carbon dioxide, argon, air or the like that is inactive to the electrochemical reaction with the power generation. The ejector 17 of the fuel cartridge disclosed here has a structure wherein it is opened when the detachable device 16 is coupled to the fuel tank 7 as shown in FIG. 3 and it is closed when the detachable mechanism 16 is separated from the fuel tank 7. The aqueous methanol solution 8 (aqueous solution fuel) and propellant gas are sealed in the cartridge container under an ordinary temperature (20° C.) and atmospheric pressure (1 atmosphere).

With the state where the ejector 17 is opened, the propellant gas carries the aqueous solution fuel in the liquid tube 20 by an ejection effect and transports the same into the fuel tank. In the cartridge disclosed here, the atmospheric pressures in the propellant gas chamber 18 and the space in the fuel chamber 19 are adjusted to be generally equal to each other in the ejector 17. The use of the propellant gas that is not dissolved in the aqueous solution fuel can provide a single chamber structure wherein the propellant gas chamber and the fuel chamber are put together. A cylindrical fuel cartridge is disclosed here, but the shape is not limited thereto. Any structure can be selected such as having a rectangular section or elliptic section, depending upon a shape of a device to be used or a section where the cartridge is to be attached.

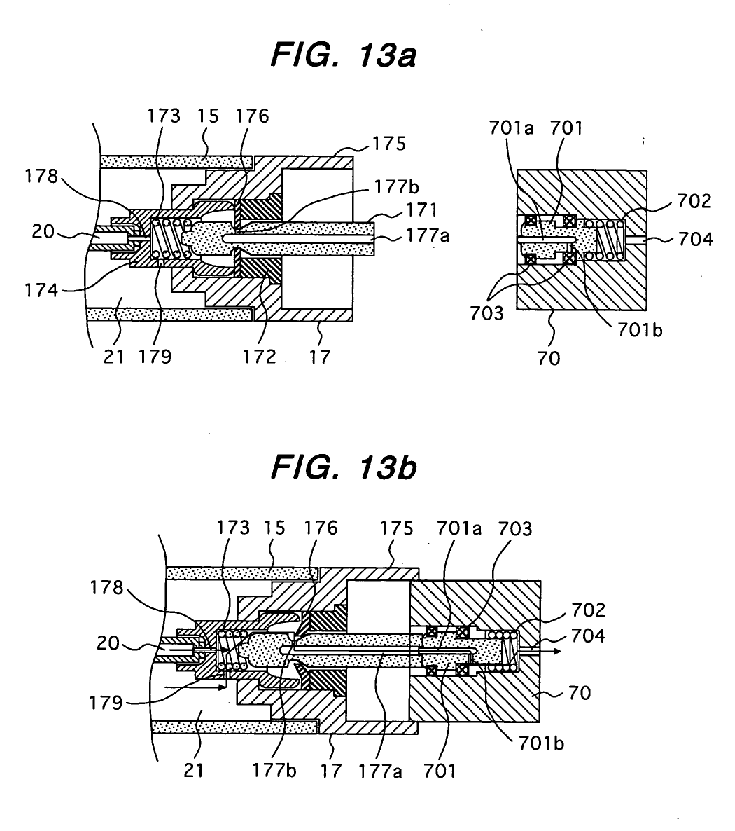

FIG. 13 shows a specific structure of the ejector 17 of the fuel cartridge and a socket 70 at the side of the fuel tank 7. More specifically, FIG. 13 shows a state before the ejector 17 and the socket 70 are connected to each other and a state after the ejector 17 and the socket 70 are connected to each other.

The ejector 17 disposed at the outlet side of the fuel cartridge 15 is composed of a nozzle 171, a nozzle guide 172, a spring 173, a holder 174, a connector section 175, a valve 176 or the like. The nozzle 171 has a fuel passage 177a provided in the axial direction at the inside thereof and a fuel passage 177b communicating with the fuel passage 177a in the diameter direction thereof. The holder 174 holds one end of the nozzle 171 via the spring 173. One end of the fuel tube 20 is connected to the side of the holder 174 opposite to the nozzle. The holder 174 is provided with a fuel guide orifice 178 and a propellant gas guide orifice 179.

Before the ejector 17 is connected to the socket 70, a returning force of the spring 173 is given to the nozzle 171, so that the nozzle is located at the position shown in FIG. 13(a). In this state, the fuel passage 171b of the nozzle 171 is located at a position closed by the valve 176. The valve 176 is made of a material having flexibility.

The socket 70 has a slider 701 having a valve function, a spring 702, a sealing 703 and an orifice 704. The slider 701 is movable in the axial direction against the force of the spring 702. The slider 701 is provided with a fuel passage 701a in the axial direction and a fuel passage 701b in the diameter direction communicating with the fuel passage 701a. Before the ejector 17 is connected to the socket 70, a returning force of the spring 702 is given to the slider 701, so that the slider is located at the position shown in FIG. 13(a). In this state, the fuel passage 701b of the slider 701 is located at a position closed by the sealing 703.

In case where the ejector 17 and the socket 70 are connected, as shown in FIG. 13(b), the inner periphery of the connector section 175 is fitted to the outer periphery of the socket 70, and the nozzle 171 and the slider 701 push each other against the force of the springs 173 and 702. Thereby the nozzle 171 and the slider 701 move backward to open the fuel passage 177b and 701b. With this state, the propellant gas 21 flows into the holder 174 via the orifice 179. Then, the aqueous solution fuel 8 flows into the fuel tank via the fuel tube 20 at the ejector side, nozzle 171 (fuel passages 177a, 177b), fuel passages 701a and 701b at the side of the socket 70 (fuel tank) and orifice 704, due to the ejection effect described below.

The ejection effect means that a pressure of a carrier liquid (propellant gas) is increased to produce a jet flow, wherein the jet flow and a carried fluid (aqueous solution fuel) are brought into contact with each other to suction the carried fluid. In this embodiment, pressure gas such as carbon gas, argon, air that is inactive to the electrochemical reaction, or high-pressure liquefied gas such as butane, flon or the like is released from the nozzle outlet, to thereby produce a jet flow. A nozzle structure in which the aqueous methanol solution fuel comes in contact with this jet flow is adopted, whereby the aqueous methanol solution fuel can be conveyed.

A material used for the fuel cartridge 15 is not particularly limited so long as it is a stable material that is not dissolved or swelled in the aqueous solution fuel, i.e., aqueous methanol solution. Examples of such material include polyethylene, polypropylene, polyethylene terephthalate, polyvinyl chloride, polyacrylic resins, epoxy resins and other engineering resins, materials thereof reinforced with various fillers, or metal materials such as stainless steel, aluminum, alumite or the like. Further, the ejector has a structure same as that used for an ordinary spray can. Its material may be any type that is not dissolved or swelled in the aqueous methanol solution or that has no corrosion occurring by the aqueous methanol solution.

The fuel tube 20 may have any type of structure having a function of bringing the ejector in constant contact with the aqueous solution fuel. This structure can be realized by using a material by which the aqueous solution fuel is wicked by a capillary attraction. Examples of preferable materials having low filling density and a superior retention for an aqueous methanol solution include natural fibers such as glass, alumina, silica-alumina, silica, non-graphite carbon, cotton, wool, paper, silk, pulp, or the like, fibers made of polyethylene, polypropylene, polyethylene terephthalate, polyvinyl chloride, polyacryl and other engineering resins, or water absorptive polymer fibers. Further, a material obtained by forming the aforesaid materials into a porous form can be used.

FIG. 5 is another embodiment of a fuel cartridge wherein the embodiment of the propellant gas is changed. The components in FIG. 5 same as those in FIG. 4 are given same numerals. In FIG. 5, high-pressure liquefied gas such as butane or flon is held as the propellant gas 22. The use of the high-pressure liquefied gas as the propellant gas can remarkably reduce the volume with a pressure-storing state, whereby the volume of the propellant gas chamber can be remarkably reduced, and hence, the energy density of the fuel cartridge can remarkably be increased. The structure of the ejection 17 is the same as that shown in the preceding FIG. 13.

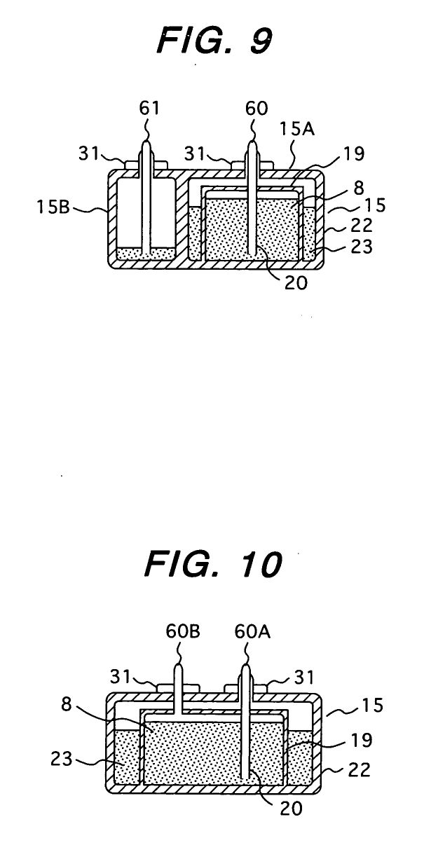

FIG. 8 shows a system configuration of a third embodiment of a fuel-feeding system according to the present invention. The different point from the first embodiment shown in FIG. 3 is that a waste liquid collection function is given to the fuel cartridge 15 without mounting an independent waste liquid collection tank 52. FIG. 9 shows one example of the fuel cartridge 15 in this case. The DMFC 13 to which the fuel cartridge 15 is to be attached may be either one of a stack type shown in FIG. 1 and a panel type shown in FIG. 2.

The fuel cartridge 15 in FIG. 9 has a waste liquid collection chamber 15B for collecting the used aqueous solution fuel from the DMFC 13, in addition to the fuel chamber 15A holding the aqueous solution fuel 8 and a propellant gas. The fuel chamber 15A is composed of an aqueous solution fuel holding section 19 and a propellant gas holding section 22 formed therearound. A liquid jet port 60 of the fuel chamber 15A is coupled to the DMFC 13 via an ejector 32 and a detachable device 31. Although the ejector 32 is provided at the side of the DMFC 13, it may be provided at the side of the cartridge instead of that. An inlet 61 of the waste liquid collection chamber 15B is connected to a used fuel discharge port (drain port) 63 of the DMFC 13 via the detachable device 31.

According to the present invention, the aqueous methanol solution in the fuel cartridge is directly fed to the DMFC 13 continuously or intermittently, whereby the waste fuel in the DMFC 13 can be collected into the fuel cartridge. In case where a fuel is continuously fed into the DMFC 13, the flow rate per unit of time of the propellant gas ejecting from the ejector 32 is set so as to be held down to a small rate, whereby the flow rate per unit of time of the aqueous methanol solution 8 ejecting from the liquid tube 20 due to its ejection effect (spraying effect) is made small. Further, the open/close of the ejector 32 or the flow rate of the ejector 32 can be controlled by a user, so that the feeding of the aqueous solution fuel can be stopped in accordance with the condition of an electronic equipment that is a subject to which power is to be supplied, or the feeding rate of the aqueous solution fuel can be controlled depending upon a load condition. Therefore, a fuel is fed with high efficiency.

It is also possible to monitor a methanol concentration of the aqueous methanol solution in the DMFC 13, and to automatically open the ejector 32 for intermittently feeding the aqueous solution fuel to the DMFC 13 when the aqueous methanol solution is used and the methanol concentration falls down to a predetermined value.

In this embodiment, the used aqueous solution fuel is collected, as a waste liquid, from the drain port of the DMFC 13 into the waste liquid collection chamber 15B in the cartridge by the amount of the aqueous solution fuel (aqueous methanol solution) fed from the fuel cartridge 15 to the DMFC 13. When the fuel in the fuel cartridge 15 is completely consumed, it is exchanged with a new fuel cartridge, and the old cartridge 15 is recovered with the waste liquid included therein.

Another embodiment of the fuel cartridge 15 is shown in FIG. 10. In FIG. 10, the fuel cartridge 15 is composed of a fuel chamber 19, a liquid tube 20 arranged in the fuel chamber 19 and a propellant gas chamber 22. The aqueous methanol solution 8 is held in the fuel chamber 19 and the propellant gas 23 is held in the propellant gas chamber 22.

In this embodiment, the fuel cartridge has a liquid jet port 60A and a liquid return port 60B for circulating the aqueous methanol solution between the fuel cartridge 15 and the DMFC 13. The liquid jet port and the liquid return port are coupled to a fuel inlet (ejector 32 in FIG. 8) and a fuel outlet (drain port 63 in FIG. 8) of the DMFC 13 for a fuel circulation. Specifically, the fuel jet port (liquid jet port) 60A and the liquid return port 60B of the fuel chamber 19 are coupled to the ejector 32 of the DMFC 13 via the detachable mechanism 31.

The ejection of the propellant gas is also utilized for the circulation of the aqueous solution fuel in this embodiment. Specifically, this embodiment provides a system wherein the aqueous methanol solution in the fuel chamber is continuously or intermittently circulated between the DMFC 13 and the fuel cartridge 15 by the adjustment or control of the ejector 32. If the fuel concentration is lowered due to repeated use (circulation) of the aqueous solution fuel, which means the time for exchange has come, the fuel cartridge 15 is exchanged with a new one. In this embodiment, a single chamber can serve as both the fuel chamber and the waste liquid collection chamber, so that the removal of the waste liquid is naturally performed with the exchange of the fuel cartridge.

In the aforesaid structure, when the amount or fuel concentration of the fuel in the DMFC 13 becomes not more than a predetermined value, an unillustrated open/close devise disposed at the ejector section 32 is opened to feed a fuel. On the other hand, when the amount or fuel concentration of the fuel in the fuel cartridge 15 becomes not more than a predetermined value, the open/close device disposed at the ejector section 32 is closed, and an alarm is given for promoting the exchange of the cartridge. At this time, an embodiment maybe adopted, according to need, wherein the open/close device is closed and the power generating operation of the power source system is stopped. It should be noted that the alarm system disclosed here can be applied to the fuel-feeding system shown in FIG. 3.

FIG. 11 shows one embodiment of an appearance of a fuel cell power generation system wherein a panel type fuel cell and the fuel cartridge according to the present invention are combined. In FIG. 11, the fuel cell power generation system is composed of a panel type cell 34 and a fuel cartridge 15. A power terminal 35 is provided at the upper section of the panel type cell 34 and the fuel cartridge 15 is attached to a detachable port 36.

Although this embodiment uses an aqueous methanol solution as an aqueous solution fuel, the invention is not limited thereto. An aqueous solution such as metal hydride or the like can also be used.

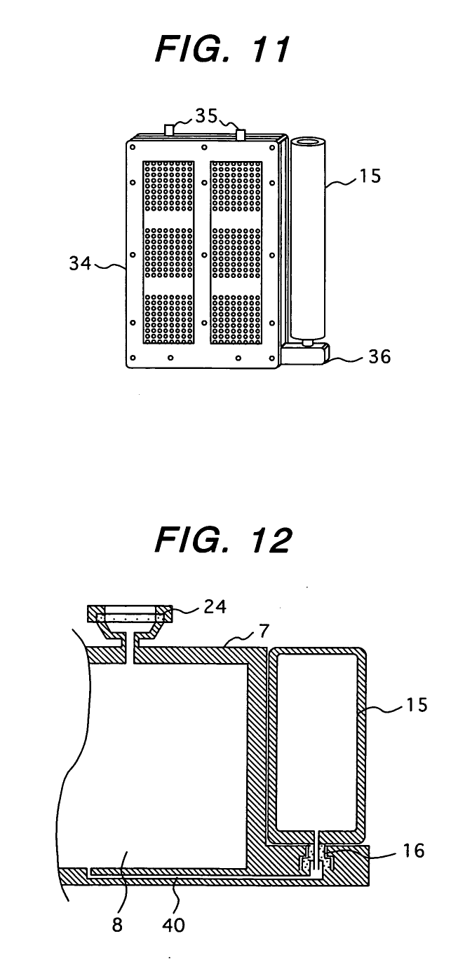

FIG. 12 is a partial sectional view showing a coupling between the fuel cartridge 15 and the fuel tank 7 of the fuel cell power generation system shown in FIG. 11. The fuel tank 7 actually has the MEA 1, cathode diffusion layer 2, anode diffusion layer 3, gasket 4, current collector 10 or the like shown in FIG. 2, but they are omitted for the convenience of drawing the view.

A fuel passage 40 provided at the side wall of the fuel tank 7 has one end coupled to the fuel cartridge 15 via the detachable device 16 and the other end coupled to the inside of the fuel tank 7.

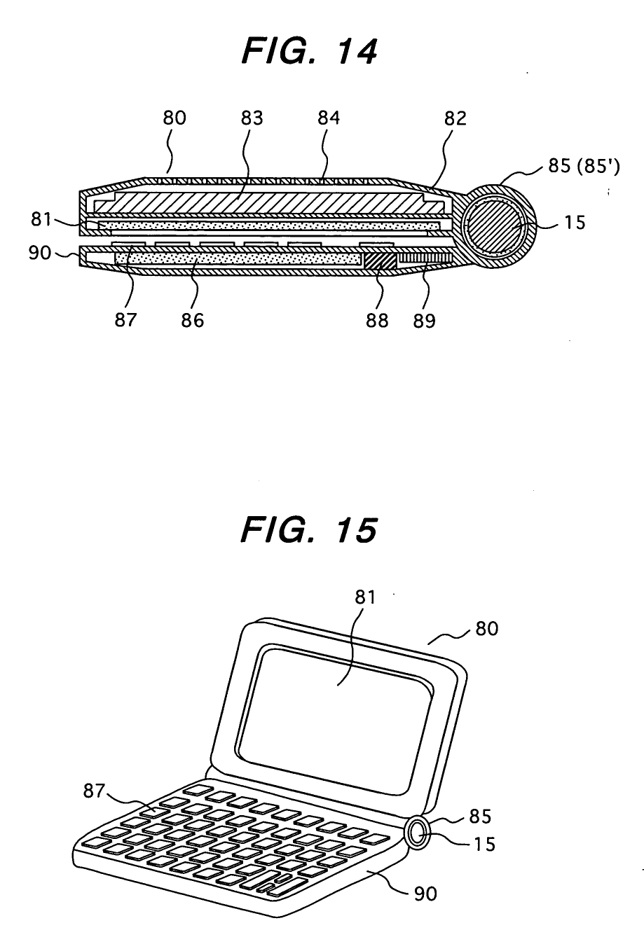

FIG. 14 is a sectional view showing that the fuel cell in the aforesaid embodiment is applied to an electronic equipment. Although a notebook type personal computer is illustrated as one example of the electronic equipment, the type of the electronic equipment is not particularly limited thereto. FIG. 15 is a perspective view of the notebook type personal computer.

In this embodiment, a fuel cell having a specification of the fuel cartridge in the foregoing embodiments is, for example, internally mounted as a main power supply at a cover 82 at the side of a display 81 of the notebook type personal computer 80. A panel type fuel cell is used as the fuel cell 83, for example.

A plurality of holes 84 for taking air from the outside (atmosphere) into the cover are formed on the cover 82. This air is used for feeding oxygen to the cathode electrode.

The fuel cartridge 15 is held into the notebook type personal computer 80 by utilizing a hinge section 85 that is provided for opening or closing the display 81. Specifically, a cylindrical housing 85′ for holding the cylindrical fuel cartridge 15 is formed at the hinge section 85. The fuel cartridge 15 is held in this housing 85′. One end of a fuel passage (not shown) joined to the fuel tank 7 of the fuel cell 83 is directed to the side wall at one end of the housing 85′ in the axial direction. When the fuel cartridge 15 is inserted into the housing 85′, the aqueous solution fuel is fed to the fuel cell 83 via the ejector. Any one of the fuel-feeding systems or waste liquid systems shown in FIGS. 3, 8, 9 and 10 is used in the fuel-feeding mechanism or waste liquid mechanism in this embodiment.

In FIG. 14, a main body 90 of the keyboard-side is equipped with a main board 86 of an electronic circuit, a keyboard 87, a power control section 88, and an auxiliary secondary battery 89 as conventionally.

1. A fuel-feeding system for a fuel cell using an aqueous solution fuel,
wherein the aqueous solution fuel is fed to the fuel cell with a propellant gas composed of a pressure gas or pressure-liquefied gas.

2. The fuel-feeding system according to claim 1,
wherein the aqueous solution fuel and the propellant gas are held in an exchangeable fuel cartridge, and an ejector for ejecting the aqueous solution fuel from the fuel cartridge to the fuel cell with the propellant gas is provided at the fuel cartridge or at the fuel cell.

3. The fuel-feeding system according to claim 1,
wherein the aqueous solution fuel is an aqueous methanol solution, and the propellant gas is composed of one or more of pressure gases such as carbon dioxide, nitrogen, argon, air or pressure-liquefied gases such as butane, flon or the like.

4. The fuel-feeding system according to claim 1,
wherein the aqueous solution fuel and the propellant gas are held in an exchangeable fuel cartridge,
the fuel cell has a fuel tank for holding the aqueous solution fuel given from the fuel cartridge and a liquid-conveying device for conveying the aqueous solution fuel from the fuel tank to the main body of the fuel cell, and
the aqueous solution fuel in the fuel cartridge can be injected at a time or successively injected into the fuel tank with the propellant gas through the ejector.

5. The fuel-feeding system according to claim 4,
wherein the fuel tank is provided with a vent for releasing only gases in the fuel tank to the outside.

6. The fuel-feeding system to claim 1,
wherein the aqueous solution fuel and the propellant gas are held in an exchangeable fuel cartridge,
the fuel cartridge has a fuel chamber for holding the aqueous solution fuel and propellant gas, and a waste liquid collection chamber for collecting the used aqueous solution fuel from the fuel cell,
a liquid jet port of the fuel chamber is coupled to a fuel inlet of the fuel cell via the ejector and an inlet of the waste liquid collection chamber is coupled to a fuel outlet of the fuel cell.

7. The fuel-feeding system according to claim 6,
wherein the fuel cartridge is provided with a vent for releasing only gases in the waste liquid collection chamber to the outside.

8. The fuel-feeding system according to claim 1,
wherein the aqueous solution fuel and the propellant gas are held in an exchangeable fuel cartridge,
the fuel cartridge has a liquid jet port and a liquid return port to circulate the aqueous solution fuel between the fuel cartridge and the fuel cell, wherein the liquid jet port and the liquid return port are respectively connected to a fuel inlet and a fuel outlet of the main body of the fuel cell for a fuel circulation, and
an ejection of the propellant gas is utilized for the circulation of the aqueous solution fuel.

9. A fuel cell using an aqueous solution fuel,
wherein an exchangeable fuel cartridge having the aqueous solution fuel and propellant gas held therein is used as a fuel-feeding source.

10. The fuel cell according to claim 9, this cell being a direct methanol fuel cell,
wherein the fuel cartridge holds an aqueous methanol solution as the aqueous solution fuel and holds one or more of pressure gases such as carbon dioxide, nitrogen, argon, air or pressure-liquefied gases such as butane, flon or the like as the propellant gas.

11. The fuel cell according to claim 9, comprising a fuel tank for holding an aqueous solution fuel given from the fuel cartridge and a liquid conveying-device for conveying the aqueous solution fuel from the fuel tank to the main body of the fuel cell from the fuel tank,
wherein the fuel tank can be replenished at a time or lo successively with the aqueous solution fuel from the fuel cartridge by utilizing an ejection effect of the propellant gas.

12. The fuel cell according to claim 9, this cell being a panel type fuel cell wherein plural MEAs are arranged on at least one surface of a flat fuel tank that holds the aqueous solution fuel,
wherein an anode of each MEA faces the fuel tank via a wicking material having a capillary attraction, and
the fuel tank is provided with a coupling for removably joining the fuel cartridge to the fuel tank and injecting the aqueous solution fuel at a time by utilizing an ejection effect of the propellant gas.

13. The fuel cell according to claim 9, comprising a fuel cell main body to which the cartridge can removably join through a coupling,
wherein a fuel-feeding passage for circulating the aqueous solution fuel between the fuel cell main body and the fuel cartridge is formed by joining the fuel cartridge to the fuel cell main body, and
the ejection of the propellant gas is utilized for the circulation of the aqueous solution fuel.

14. The fuel cell according to claim 9, comprising a fuel cell main body to which the cartridge can removably join through a coupling,
wherein the fuel cartridge has a fuel chamber for holding the aqueous solution fuel and propellant gas, and a waste liquid collection chamber for collecting the used aqueous solution fuel from the fuel cell, and
the fuel cell main body has a fuel inlet connectable to the fuel chamber of the fuel cartridge via an ejector and a fuel outlet connectable to the waste liquid collection chamber.

15. A fuel cartridge that can be exchangeably attached to a fuel cell and holds an aqueous solution fuel and a propellant gas, wherein the aqueous solution fuel can be fed to the fuel cell by the ejection of the propellant gas.

16. The fuel cartridge according to claim 15, wherein the aqueous solution fuel is an aqueous methanol solution, and the propellant gas is composed of one or more of pressure gases such as carbon gas, nitrogen gas, argon gas, air or pressure-liquefied gases such as butane, flon or the like.

17. The fuel cartridge according to claim 15, comprising a fuel chamber for holding the aqueous solution fuel and propellant gas, and a waste liquid collection chamber for collecting the used aqueous solution fuel from the fuel cell.

18. The fuel cartridge according to claim 17, provided with a vent for releasing only gases in the waste liquid collection chamber to the outside.

19. The fuel cartridge according to claim 15, comprising a liquid jet port and a liquid return port to circulate the aqueous solution fuel between the fuel cartridge and the fuel cell.

20. A fuel cartridge according to claim 19,
wherein the fuel chamber holding the aqueous solution fuel is provided with a vent for releasing only gases in the fuel chamber.

21. An electronic device having a fuel cell as a power source, comprising a fuel cell using an aqueous solution fuel and an exchangeable fuel cartridge, as a fuel supply source for the fuel cell, having the aqueous solution fuel and a propellant gas filled therein.

22. An electronic equipment having a fuel cell as a power source, comprising a fuel cell using an aqueous solution fuel, and an exchangeable fuel cartridge as a fuel supply source for the fuel cell, having the aqueous solution fuel and a propellant gas held therein,
wherein the fuel cell is any one of fuel cells claimed in claims 10 to 14.

23. The electronic equipment according to claim 22, this electronic device being a personal computer or mobile having a reclosable display,
wherein the fuel cell is placed in a cover of the display and an air vent for supplying oxygen to the fuel cell is provided at the cover.

24. The electronic equipment according to claim 23,
wherein a housing for holding the fuel cartridge is formed at a hinge section for opening/closing the display.
